(19) United States
(12) Patent Application Publication
(10) Pub. No.: US 2017/0284133 A1
(43) Pub. Date: Oct. 5, 2017

(54) ANTI-VANDALISM PADLOCK

(71) Applicant: Alejandro Esteban PELAEZ, Rio Negro (AR)

(72) Inventor: Alejandro Esteban PELAEZ, Rio Negro (AR)

(21) Appl. No.: 15/507,664

(22) PCT Filed: Aug. 6, 2015
(86) PCT No.: PCT/EP2015/001622

§ 371 Date: Feb. 28, 2017

(30) Foreign Application Priority Data
Aug. 29, 2014 (AR) P20140103255

(51) Int. Cl. E05B 67/36; E05C 7/04; E05B 67/06; E05B 63/04

(52) U.S. Cl. CPC E05B 67/36; E05B 63/042; E05C 7/04; E05B 67/06; E05B 47/00

(57) ABSTRACT

Anti-vandalism padlocks are used to secure chains, latches or similar elements, consisting of two coupling armours, with a particular geometry according to their application, with a tumbler cam lock. This padlock does not have an exposed shackle nor any other similar element which may be subject to violation either by cutting, lever movements or the like.

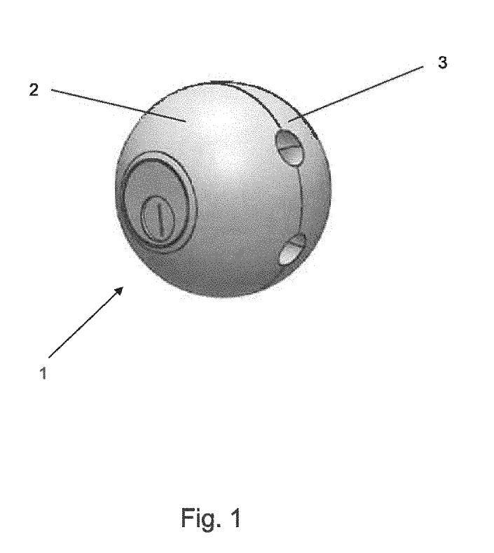

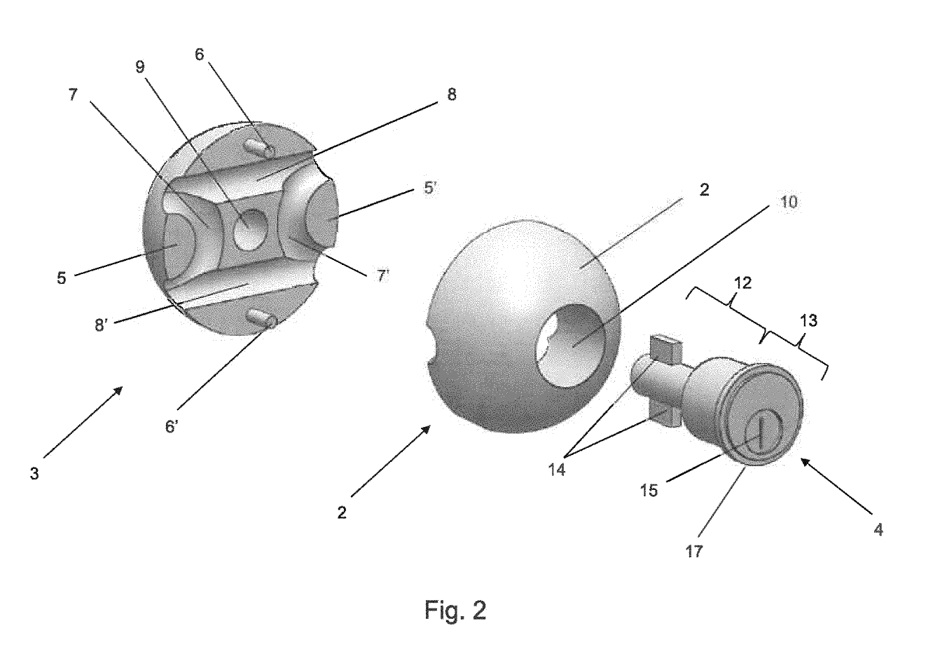

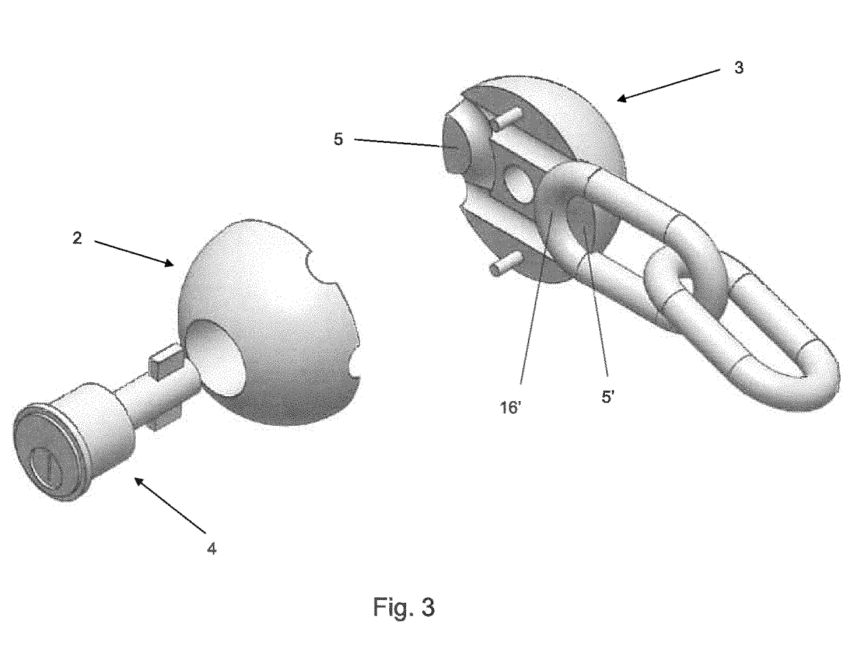

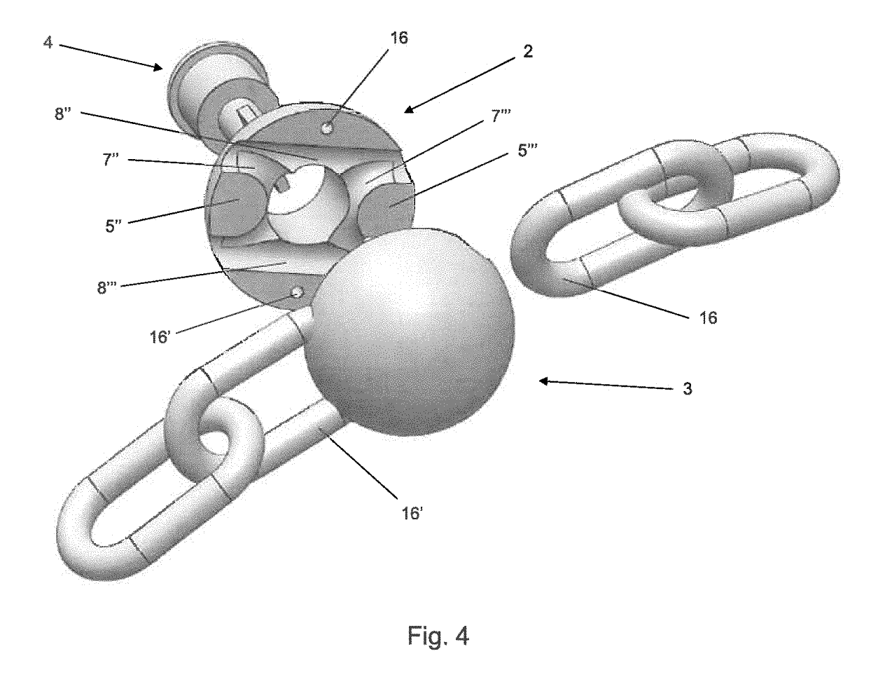

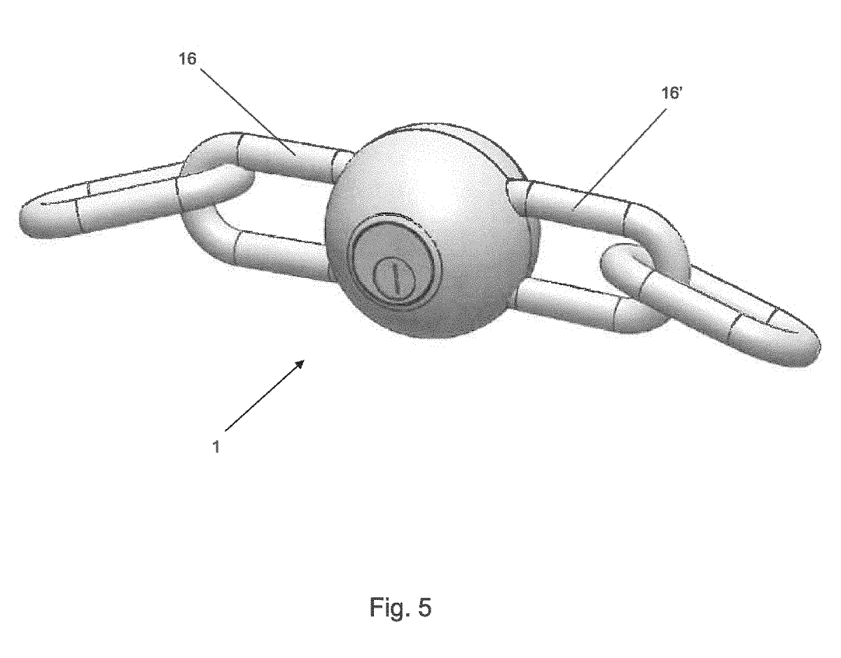

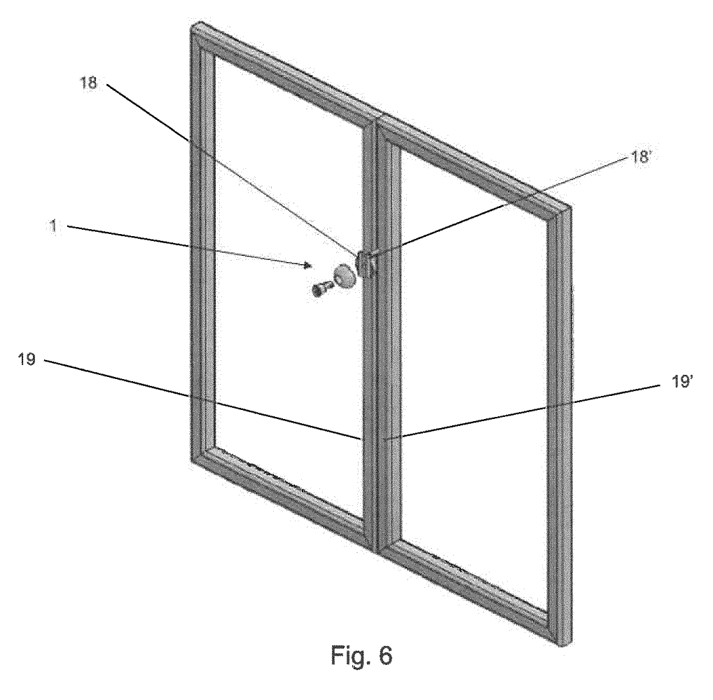

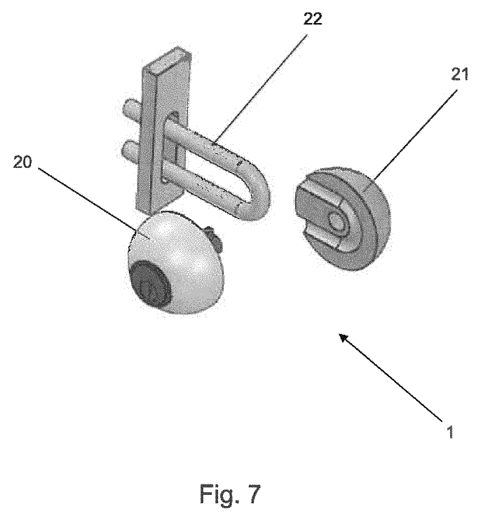

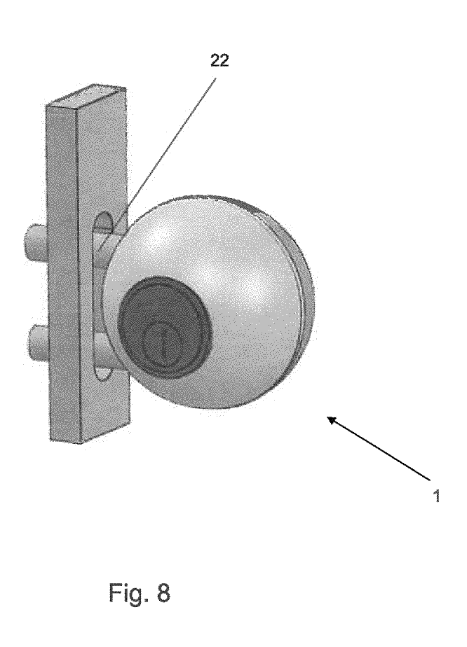

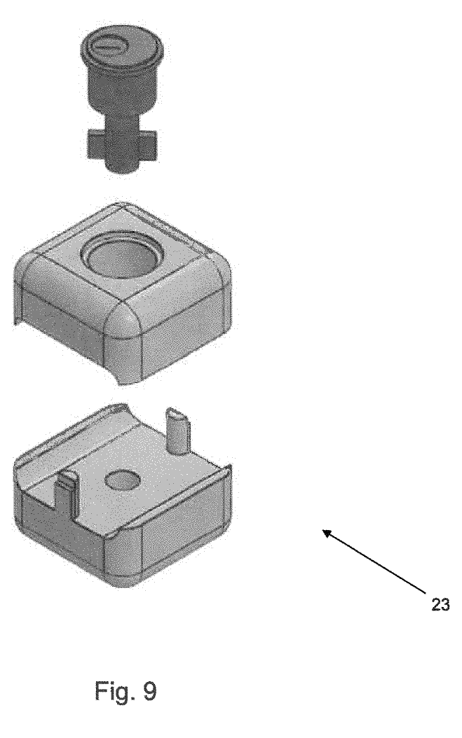

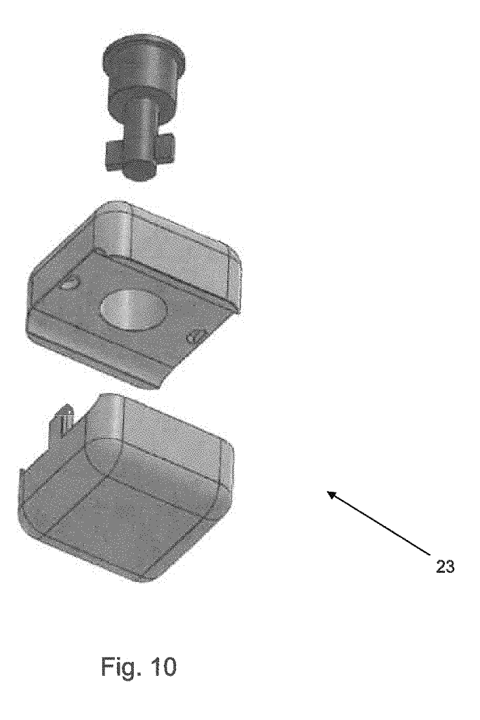

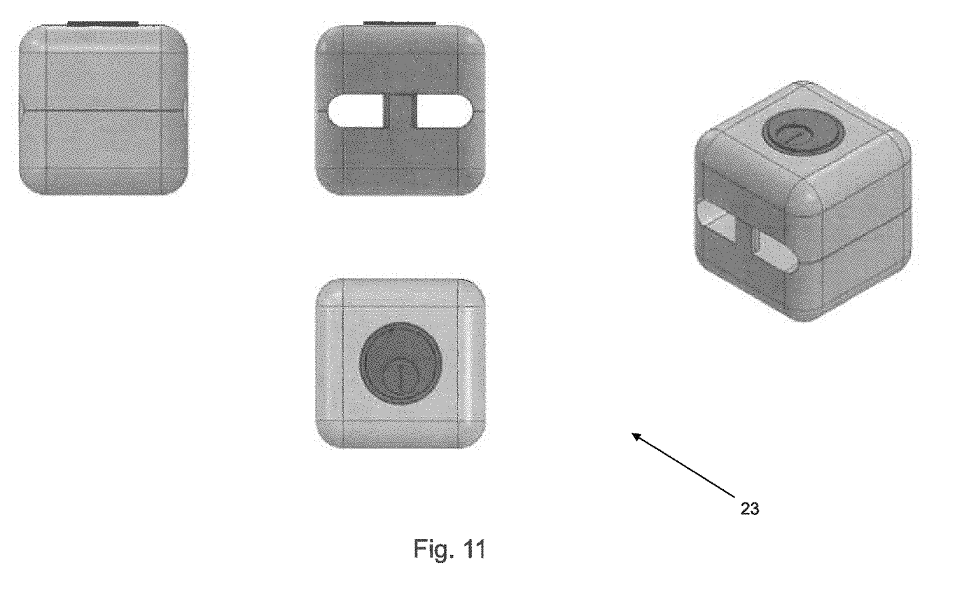

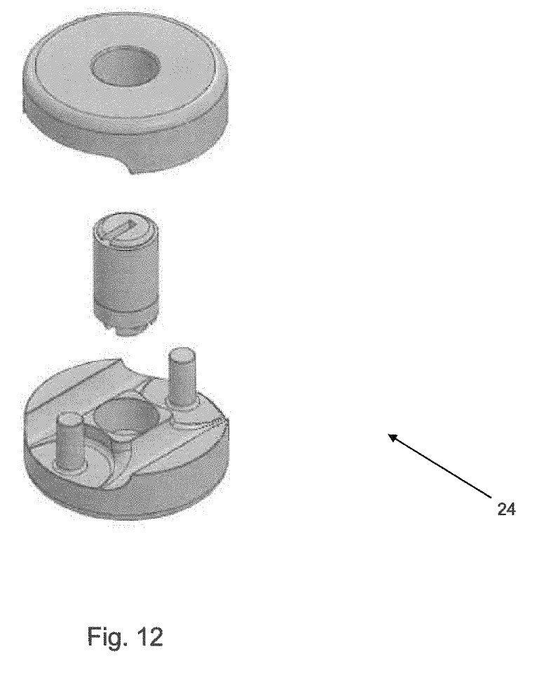

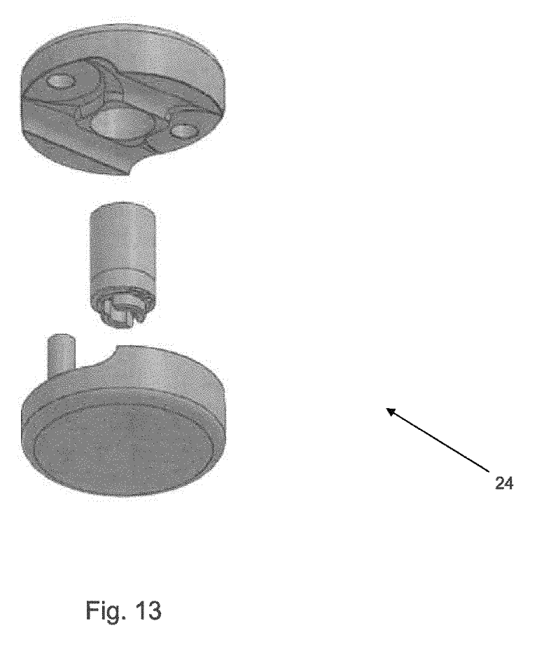

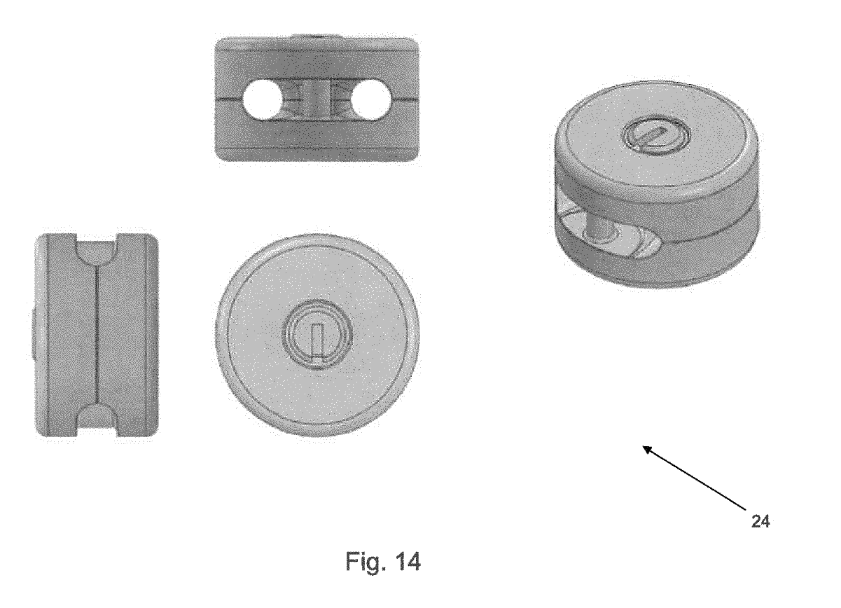

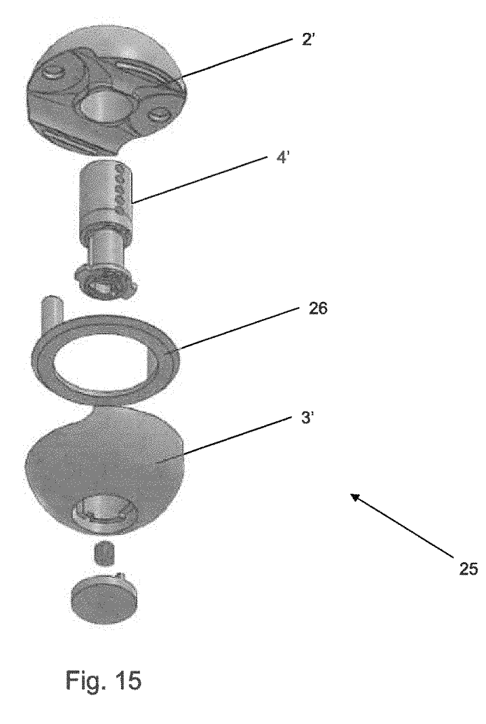

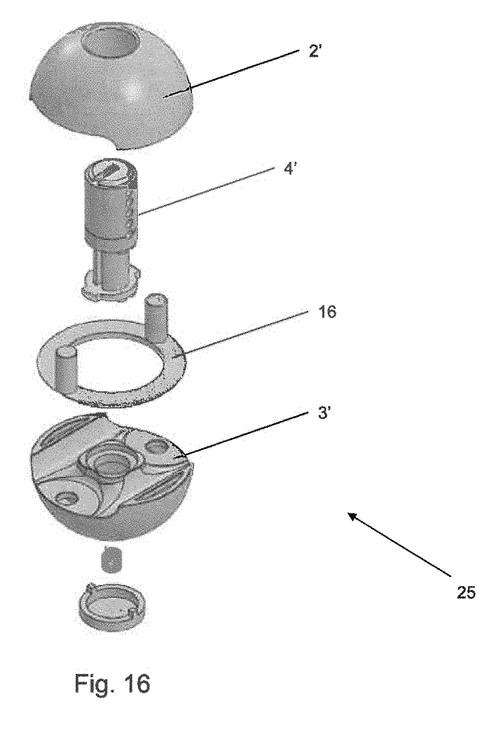

### BACKGROUND OF THE INVENTION

### 1. Field of the Invention

This invention relates to an anti-vandalism padlock used to secure chains, latches or the like, which provides special protection against opening or violation due to its special construction.

Padlocks have been used for centuries. Their history dates back to the end of the XVII century when Federico Javier Pittón founded a factory in Stjünsund (Stamsund), a village located in one of the islands of the current Norwegian territory, where he invented and manufactured, among other elements, a padlock known as the Scandinavian “Polhem”. Two centuries and a half later, Harry Soref founded the company Master Lock and in 1921 he patented a padlock, updating the Scandinavian model. In April 1924 he sold the padlock patent. Soref's padlock was strong and cheap because it was covered by layers of a kind of metal similar to the one used for the construction of bank doors. He later introduced the same padlock using laminated steel.

By definition, a padlock is a safety device used as a portable lock when doors are not equipped with a lock themselves, or when, for practical or economic reasons there is no conventional lock. Actually, a padlock is generally much cheaper and much easier to use. A padlock is specially suitable for large metallic doors that are locked with steel chains. In order to close that kind of doors, a padlock is used by inserting its shackle through the chain links and locking it.

Padlocks may be used in a wide variety of everyday activities, mainly for doors that are not commonly used, to prevent thieves or intruders from trespassing private property, burglaries, sabotages and other acts of vandalism. The most sophisticated and the biggest padlocks are used to block metallic doors locked with chains.

Padlocks are so popular and massive that it would not make much sense to describe those currently used. However, just for the sake of naming their parts, we can say that padlocks are composed of a solid body with a locking mechanism inside to close and block the shackle. The shackle is inserted through the links of at least one chain or directly in a latch. Regarding the closing mechanism, technological advances have spared the need of keys. Nowadays padlocks may be closed using mechanical passwords (combinations), electronic passwords, or even fingerprint scanners (known as digital padlocks, owned by Mintpass), which simply recognize the registered users' fingerprint in order to open.

However, in spite of their long history, current padlocks have a weak spot, which, despite many attempts, has never been improved. For both conventional and unconventional padlocks, the drawback is that the shackle is exposed. This happens even in the case of armoured padlocks. Even when the length of the exposed shackle is reduced, there is always a part of it that remains exposed to being cut with manual, pneumatic or hydraulic scissors or pliers. Similarly, padlocks are violated with cutting tools such as saws of longitudinal or circular teeth, broken by impacts or unlocked with lever movements. The same may be achieved by using abrasive cutting elements, such as manual files or electric elements or elements otherwise fed such as “Dremel” portable stones or circular grinders.

### 2. Description of the Related Art

In all of these cases the drawback to date is the same: the shackle remains exposed either totally or partially and therefore burglaries or acts of vandalism cannot be prevented. For example, this is the case for document US2006123856 describing a lock comprising an exposed shackle.

This revolutionary and easy-to-use invention has come to eliminate this drawback.

Documents DE4436053 and GB2414034 describe additional padlocks that does not comprise shackles, but indentations adapted to receive either straight or curved elements to link. Contrary to the prior art, the invention concerns a padlock that does not comprise shackles, but indentations adapted to receive both straight or curved elements to link.

### SUMMARY OF THE INVENTION

The purposes of this invention are firstly, to create an anti-vandalism padlock which does not use a shackle to link elements; secondly, to create an anti-vandalism padlock with a closing system that encloses both of the linked elements; thirdly, to create an anti-vandalism padlock with a decorative and aesthetic shape, upgrading the existing ones; forthly, this invention is intended to set the basis for a new concept of padlocks, with multiple uses and a higher level of security; finally, this invention is aimed at creating an anti-vandalism padlock with a spherical geometric exterior shape, and a uniform rigidity in all its exterior surface, all of which is aimed at preventing the padlock from being subject to acts of violence.

### BRIEF DESCRIPTION OF THE DRAWINGS

Picture 1 shows an overall perspective view of an example of a closed anti-vandalism padlock.

Picture 2 shows each of the three basic pieces of the example of anti-vandalism padlock mentioned above, open and with the stick off.

Picture 3 shows a view similar to the one in picture 2. In this case the padlock is inserted in a link of a chain.

Picture 4 shows each piece of the example of anti-vandalism padlock separately, from the opposite angle than that of pictures 2 and 3, in order to show other aspects of it. In this case the picture also shows a chain ready to be secured.

Picture 5 shows the example of a closed anti-vandalism padlock, securing 2 chains or the extremes of the same chain.

Picture 6 shows the separate pieces of an example of an open spherical anti-vandalism padlock, locking the latch of a double gate.

Picture 7 shows the example of an open anti-vandalism padlock closing a bolt.

Picture 8 shows the same example of a closed anti-vandalism padlock as picture 7 blocking a bolt.

Picture 9 shows a downward perspective view of a second example of an open anti-vandalism padlock.

Picture 10 shows an upward perspective view of the second example of an open anti-vandalism padlock.

Picture 11 shows multiple perspective views of a closed anti-vandalism padlock.

Picture 12 shows a downward perspective view of a third example of an open anti-vandalism padlock.

Picture 13 shows an upward perspective view of a third example of an open anti-vandalism padlock.

Picture 14 shows multiple views in perspective of the third example of a closed anti-vandalism padlock.

Picture 15 shows an upward perspective view of a forth example of an open anti-vandalism padlock.

Picture 16 shows a downward perspective view of the fourth example of an open anti-vandalism padlock.

### DETAILED DESCRIPTION OF THE PREFERRED EMBODIMENT

The following description will be supported by pictures 1 through 5 in order to make it clear and comprehensible.

Due to the fact that padlocks may be used to link the extremes of one of more chains, latches or the like or a combination of both, from now on they will be referred to as “elements to link”. This is worth mentioning because it would be incorrect to refer to padlocks as “elements to secure” as chains, latches, etc. are the elements used to secure other elements (money, private property, luggage, etc). For the example, the first element to link is the first link of a chain, referred to as 16 and the second element to link is the second link of a chain, referred to as 16′. Padlock 1 may be used, for example, to lock a double gate with a latch in each of the two parts of the gate or one latch attached to a wall and the other one to the gate.

Anti-vandalism padlock 1 has an anterior armour 2, a posterior armour 3 and a tumbler cam lock 4. The cutting faces of the anterior armour 2 and the posterior armour 3 are mutually attached. In this way, they both conform only one structure. The tumbler cam lock 4 is inserted from the exterior face of the anterior armour 2, to the plain cutting face of said armour through a passing aperture 10 on the symmetry axis of the anterior armour 2. The tumbler cam lock 4 is also inserted through one non-passing aperture 9 projected out with the symmetry axis of the posterior armour 3, inserted from the plain cutting face of the posterior armour 3 to the interior of said armour. The features of the tumbler cam lock 4 will be dealt with later. In the meantime, it is worth mentioning that the tumbler cam lock 4 is the means of attachment between the anterior armour 2 and the posterior armour 3.

As it was mentioned earlier, the main advantage of example 1 of anti-vandalism padlocks of this invention, is the absence of a shackle and therefore the lack of exposure to violation. To this end, the interlocking relationship between a first element to link 16 and a second element to link 16′, is placed between the plain cutting faces of the anterior armour 2 and the posterior armour 3.

The said interlocking relationship between the first element to link 16 and the second element to link 16′ is partially defined in the anterior armour 2 and the posterior armour 3, which are complementary when they are interlocked.

The description above can be clearly seen in picture 4.

In the case of the anterior armour 2, the interlocking relationship is defined by a first curved semicircular indentation 7″ and a second curved semicircular indentation 7′″. These curved indentations 7″ and 7′″ have their axis of radius geometrically placed on the perimeter of the plain cutting face and opposite to each other. In order to be completely opposite to each other, they are placed in a 180° angle between each other. Considering the previously mentioned aperture 10 and indentations 7″ and 7′″, a first plain protrusion 5″ and a second plain protrusion 5′″ are defined diametrically opposite to each other. The angular disposition of protrusions 5″ and 5′″ will depend on the application for which the padlock was created. Therefore these protrusions need not always be at exactly 180°, they may be geometrically placed in a different angle, even at 90° so that both of the elements to link 16 and 16′ are inserted with this angle. Furthermore, they could be at 360°, in which case both protrusions 5″ and 5′″ would be parallel to each other.

The following description may be clearly seen in picture 2.

Regarding posterior armour 3, the interlocking relationship is defined by the first curved semicircular indentation 7 and the second curved semicircular protrusion 7′. These curved indentation 7 and 7″ have their axis of radius geometrically placed on the perimeter of the plain cutting face and in the opposite way (at a 180° angle, as an example) This way, just as in the case of anterior armour 2, a first plain protrusion 5 and a second plain protrusion 5′ are defined on the cutting face of posterior armour 3 in an opposite way.

Apart from the angular disposition, which, as it was mentioned before, depends on the application of the padlock, there must be absolute symmetry between the anterior armour 2 and the posterior armour 3 so that the first and the second protrusions 5 and 5′ on the posterior armour 3 are respectively coupled with the first and the second protrusions 5″ and 5′″ on the anterior armour 2.

The type of indentations and protrusions described above allow to place the first element to link 16 (which in this example is the extreme of a chain), due to the joint action of protrusions 5 and 5′″ and curved indentations 7 and 7′″. While the second element to link 16′ (which in this example is the other extreme of the same chain), will be coupled due to the joint action of protrusions 5′ and 5″ and curved indentations 7′ and 7″.

In accordance with the paragraph above, the same would happen if the first element to link 16 and the second element to link 16′ are links in the extremes of two different chains.

In example 1 of the anti-vandalism padlock, the interlocking means between the first element to link 16 and the second element to link 16′ are defined, in the anterior armour 2, by a first straight indentation 8″ and a second straight indentation 8′″, which are parallel to each other; while, in the posterior armour 3, the interlocking means are defined by a first plain indentation 8 and a second plain indentation 8′, both parallel to each other. In this way, these first and second plain indentations 8 and 8′, couple with the respective first and second indentations 8″ and 8′″ in the anterior armour 2. That is to say, indentations 8 and 8″ couple with indentations 8″ and 8′″. This is the case in which it is necessary to securely link straight elements, for instance latches of a door or gate, a tool box, etc.

Picture 6 shows an example of application of padlocks to link straight elements. Said picture shows a spheric anti-vandalism padlock 1, in its open form and its separate pieces, used to link two straight latches 18 and 18′ attached to both doors 19 and 19′ of a double gate.

In the design, as shown with the example in pictures 1 through 5, padlocks able to function interchangeably with curved and straight interlocking means are more versatile. To this end, from the construction point of view, the first straight indentation 8″ and the second straight indentation 8′″ defined on the cutting face of anterior armour 2, project out from the respective superior and inferior extremes of the first curved indentation 7″ and the second curved indentation 7′″. While in the cutting face of posterior armour 3, the first straight indentation 8 and the second straight indentation 81 project out from the respective superior and inferior extremes of the first curved indentation 7 and the second curved indentation 7′.

In line with the paragraphs above, there follow the construction details of the tumbler cam lock 4. The tumbler cam lock is cylindrical. Along its geometry, the first anterior part is narrow, with a maximum diameter of 17, which can not be inserted in the passing aperture 10 on the symmetry axis of the anterior armour 2. The second part has a medium diameter 13, which can be inserted in the passing aperture 10 on the symmetry axis of the anterior armour 2. Further along its geometry, the tumbler cam lock also comprises a third posterior part with a narrower diameter 12, which can be inserted in aperture 9 of the posterior armour 3. The anchorage means 14 are placed in this third posterior narrower part 12. These allow the tumbler cam lock to couple with the posterior armour 9 in a safe way. In this way, the blocking system of this revolutionary padlock consists of the joint action of the first part of the tumbler cam lock, with a wider diameter 17 which blocks the movement of the anterior armour 2 and the anchorage means 14 which have the same function for the posterior armour 3.

The anchorage means 14 may consist of pallets, bolts or any other closing means. Needless to say, the posterior armour 3 must have the internal shape necessary to enclose said anchorage means 14. Nevertheless, this detail is irrelevant because it will depend on the type of anchorage means. It even depends on the selected type of tumbler cam lock 4 being that the tumbler may be taken from a generic one or it may be an adaptation of the tumblers in the market.

Both the padlock locking and unlocking depend on the position of the bolt 15. It may be switched from the “open” or “closed” positions using a key or a similar element characteristic of the tumbler cam lock.

It is worth mentioning that the type of mechanism used by the tumbler cam lock does not limit the invention. That is to say that for the example, the tumbler cam lock used was a standard one which opens with a key. However, the tumbler cam lock appropriate for a “digital padlock” could be one operated by fingerprint recognition, by entering a numeric code, by a radio frequency identification card, Bluetooth® connection through software code validation installed in the cellphone of the padlock user, etc.

Notwithstanding the pictures there are no suggestions for the geometric exterior shape of the anterior 2 and posterior 3 armours. They could be cubic, cylindrical, etc., depending on the application of the padlock. However, it is worth mentioning that the anterior 2 and posterior 3 armours of the padlock in example 1 are perfect hemispheres externally. In this way, when coupled, the anterior 2 and posterior 3 armours define a perfect spheric external geometric structure. This feature makes the closed padlock difficult to handle in order to violate it, increasing its safety level.

As it is shown in the pictures, between the cutting faces of the anterior armour 2 and the posterior armour 3, there may exist centralized positioning means so that there is a perfect coupling of both pieces between their protrusions and indentations which make up the correct closing and attaching of both of the elements to link.

In the example, the positioning means are the apertures 16 and 16′ on the plain cutting face of the anterior armour 2 and the bolts 6 and 6′ with their respective apertures 16 and 16′.

From the manufacturing point of view, in order to produce the anti-vandalism padlocks introduced by this invention, the anterior 2 and posterior 3 armours may be mechanized on metallic pieces of, for instance, steel, bronze or the like, made of an aluminium alloy through an injection process, etc. Another alternative is through the injection of polymers in specially made molds. To this end, engineering plastics or high resistance polymers such as Nylon 66 ® with glass fibre, may be considered for padlock manufacturing, as they need a high safety level.

Pictures 7 and 8 show another example of anti-vandalism padlock 1, where their armours 20 and 21 can be seen blocking the bolt 22. Picture 9 shows a downward perspective view of a second example of an open anti-vandalism padlock.

In order to conclude the description and with pictures 9, 10 and 11 a second example may be introduced (reference number 23). Conceptually it relates to an anti-vandalism padlock as the one described above. However, its tridimensional development shows a cubic shape, in this case with round edges.

Pictures 12, 13 and 14 introduce a third example (reference number 24). In this case, anti-vandalism padlock 24 introduces a tridimensional development with a short cylindric shape, with round edges in this case.

Finally, pictures 15 and 16 introduce a fourth example of the anti-vandalism padlock (reference number 25). In this example an improved locking device was used, with respect to the one used in picture 1. Conceptually it is the same. However, in this case, details in the blocking mechanism were introduced as well as a metallic core in the posterior armour 3′ (inferior in the picture), and there may be a coupling counterpart in the anterior armour 2′ (superior in the picture).

This metallic core 26 is intended to bolster the padlock from the very beginning, for the case of armours made of polymers through injection processes. The metallic core 26 may be made of any metal, steel preferably.

As any expert in this subject would understand, this patent application is aimed at describing the concept of the invention. Nevertheless, it is worth mentioning that any modifications of this invention, either in its size, composition, shape, adaptations, etc., following the same development concept and included in the protection herein shall be enclosed by this patent application.

1) An antivandalism padlock (1) comprising an anterior armour (2), a posterior armour (3) and a tumbler cam lock (4), the anterior and posterior armours couple mutually in their respective cutting faces forming only one structure, the tumbler cam lock (4) being inserted from an exterior face of the anterior armour (2) to a plain cutting face of said armour through a passing aperture on an axis of symmetry of the anterior armour (2) and through a non-passing aperture, which projects out parallel to a symmetry axis of said posterior armour (3) from a plain cutting face of said posterior armour (3) to its interior, the locking device constituting attachment means between the anterior and posterior armours, wherein there also are coupling means on the plain cutting faces of said posterior and anterior armours between a first element to link and a second element to link, wherein said coupling means of the first and the second elements to link are defined on the anterior armour (2) by a first and a second straight indentations (8″, 8′″), which are parallel between each other, and in the posterior armour (3) said coupling means are defined by said first and a second straight indentations (8″, 8′″), which are parallel between each other, these first and second indentations couple corresponding to the respective first and second indentations on the opposite armour, characterized in that the first and the second straight indentations (8″, 8′″), defined on the cutting face of the anterior armour, project out from the respective superior and inferior extremes of first and second curved semicircular indentations (7″, 7′″).

2) The anti-vandalism padlock (1) according to claim 1, characterized in that said coupling means between the first and the second elements to link are defined on the anterior armour by the first curved semicircular indentation and the second curved semicircular indentation, both with radius axis geometrically placed on the perimeter on their plain cutting faces and opposite to each other, wherein opposite to these are a first plain protrusion and a second plain protrusion, In the posterior armour, said coupling means are defined by a first curved semicircular indentation and a second curved semicircular indentation, both of which are conformed with radius axis geometrically placed on the perimeter of the plain cutting face and opposite to each other, wherein opposite to these are a first plain protrusion and a second plain protrusion, which couple with respective first and second protrusions (5″) and (5′″) on the anterior armour.

3) (canceled)

4) (canceled)

5) (canceled)

6) (canceled)

7) The anti-vandalism padlock (1) according to claim 2, characterized in that the first and the second straight indentations (8″, 8′″) defined on the cutting face of the posterior armour project out from the respective superior and inferior extremes of the first and the second curved indentation (7″, 7′″).

8) The anti-vandalism padlock (1) according to claim 7, characterized in that it has a cylindrical tumbler cam lock, wherein along its geometry, this cylindrical tumbler cam lock, has a first anterior part, with a first diameter, which cannot be inserted in the passing aperture on the symmetrical axis of the anterior armour, wherein the second part, with a second diameter, can be inserted in the passing aperture on the symmetry axis of the anterior armour, wherein the third posterior part, with a third diameter may be inserted in the aperture on the posterior armour, wherein on this third part is anchorage means for coupling with the posterior controlled between the “open” or “closed” armour, selectively with a key or a similar element characteristic of this locking device.

9) The anti-vandalism padlock (1) according to claim 8, characterized in that the anterior and posterior armour are perfect hemispheres on their exterior surface, wherein consequently, when coupled, they conform a perfect spherical structure.

10) The anti-vandalism padlock (1) according to claim 9, characterized in that there are correct positioning and centering means between the cutting faces of the anterior and posterior armours.

11) The anti-vandalism padlock (1) according to claim 10, characterized in that its anterior and posterior armours are built with a metallic material.

12) The anti-vandalism padlock (1) according to claim 11, characterized in that its anterior and posterior armours are built with a high resistant polymer.

13) The anti-vandalism padlock (1) according to claim 12, characterized in that the anchorage means are pallets and bolts.

14) An anti-vandalism padlock (1) according to claim 2 characterized in that said first and second elements to link are links of only one chain.

15) An anti-vandalism padlock (1) according to claim 2 characterized in that said first and second elements to link are the links of extremes of two different chains.

16) The anti-vandalism padlock (1) according to claim 1, to secure elements to link chains and/or latches.
